(19) United States
(12) Patent Application Publication
(10) Pub. No.: US 2013/0180663 A1
(43) Pub. Date: Jul. 18, 2013

(54) Tooling Systems and Methods for Composite Parts

(71) Applicant: JANICKI INDUSTRIES, INC., Sedro Woolley, WA (US)

(72) Inventors: Edward M. West, Sedro Woolley, WA (US); William Brian Holmes, Sedro Woolley, WA (US); Curtiss E. Melder, Sedro Woolley, WA (US); Jeffrey D. Steensland, Sedro Woolley, WA (US); Gregory R. Applewhite, Sedro Woolley, WA (US)

(73) Assignee: JANICKI INDUSTRIES, INC., Sedro Woolley, WA (US)

(21) Appl. No.: 13/733,700

(22) Filed: Jan. 3, 2013

Related U.S. Application Data
(60) Provisional application No. 61/582,807, filed on Jan. 3, 2012.

(51) Int. Cl. B29C 70/00

(52) U.S. Cl. CPC B29C 70/00
USPC 156/349; 29/505

(57) ABSTRACT

A tooling system for forming a part comprises a sheet structure, a truss structure, and an attachment system. The sheet structure is a carbon fiber composite structure and defines a mold surface for defining at least a portion of the part. The truss structure comprises a plurality of truss components. The truss components are tubular and are made of Invar. At least one end of each of the truss components is crimped. Crimped ends of the truss components are welded to other truss components to form the truss structure. The attachment system secures the sheet structure to the truss structure.

### RELATED APPLICATIONS

This application (Attorney's Ref. No. P217197) claims priority benefit of U.S. Provisional Application Ser. No. 61/582,807 filed Jan. 3, 2012, the contents of which are incorporated herein by reference.

### TECHNICAL FIELD

The present invention relates to tooling systems and methods and, more particularly, to tooling systems and methods for composite parts formed using elevated temperatures.

### BACKGROUND

A tooling system for a composite part typically comprises a face sheet defining a mold surface configured to define a shape of a surface of the composite part and a support structure for allowing the mold surface to be transported and supported during manufacture of the composite part. For a composite part, the mold surface is desirably made of composite materials. For many types of composite parts, the part must be heated during manufacture. Accordingly, the tooling system must be capable of cycling through a number of heating and cooling cycles to make that number of composite parts.

Carbon fiber composite parts, and mold surfaces made from carbon fiber composite materials, have a coefficient of thermal expansion that is low in comparison to most metals. Accordingly, most metals are unsuitable for use as the support structure for tooling systems having a carbon fiber composite mold surface and that are subject to heating and cooling during use thereof.

Invar is a nickel-iron alloy having a coefficient of thermal expansion that substantially matches that of composite materials used as a mold surface and the composite parts made using such mold surfaces. Invar is sold in sheets and is very heavy and expensive. Further, to be used as a support structure for a tooling system for a composite part, the sheets of Invar typically require a substantial amount of engineering to build a structure that can be assembled from sheets of Invar for a particular mold surface and which has the minimum weight required for a given set of structural requirements.

Given the cost of Invar and the engineering required to build a support structure of Invar, tooling systems for composite parts that are subject to heating and cooling during use are very expensive and thus suitable only for applications where such costs can be borne. Further, after a tooling system employing a conventional Invar support structure has reached the end of its useful life, the parts forming the Invar support structure cannot be reused but must be recycled back into Invar sheets.

The need thus exists for improved tooling systems for composite parts that can be repeatedly heated and cooled during manufacture of the composite parts and which allow the Invar components thereof to be reused.

### SUMMARY

The present invention may be embodied as a tooling system for forming a part comprising a sheet structure, a truss structure, and an attachment system. The sheet structure is a carbon fiber composite structure and defines a mold surface for defining at least a portion of the part. The truss structure comprises a plurality of truss components. The truss components are tubular and are made of Invar. At least one end of each of the truss components is crimped. Crimped ends of the truss components are welded to other truss components to form the truss structure. The attachment system secures the sheet structure to the truss structure.

The present invention may also be embodied as a method of forming a tooling system for forming a part comprising the following steps. A sheet structure defining a mold surface for defining at least a portion of the part is provided, where the sheet structure is a carbon fiber composite structure. A plurality of tubular truss components made of Invar is provided. At least one end of each of the truss components is crimped. A truss structure is formed by welding the crimped ends of the truss components to other truss components. The sheet structure is secured to the truss structure.

The present invention may also be embodied as a method of forming a tooling system for forming a part comprising the following steps. A sheet structure defining a mold surface for defining at least a portion of the part is provided, where the sheet structure is a carbon fiber composite structure. A plurality of flat plates made of Invar is provided. Each of the plurality of flat plates is formed into a cylindrical configuration. A plurality of tubular truss components is formed by welding each of the flat plates along a seam to form the truss components. At least one end of each of the truss components is crimped. At least one of the crimped ends of one of the truss components is sheared. A truss structure is formed by welding the crimped ends of the truss components to other truss components. The sheet structure is secured to the truss structure.

### BRIEF DESCRIPTION OF THE DRAWINGS

FIG. 1 is a perspective view of a first example tooling system of the present invention;

FIG. 2 is a perspective view of example stock material that may be used to make the first example tooling system;

FIG. 3 depicts an example geometric shape of an example stock member into which the stock material of FIG. 2 is formed to make the first example tooling system;

FIGS. 4 and 5 depict one example method of processing of the stock member of FIG. 3 to make the first example tooling system;

FIGS. 6 and 7 depict the stock member of FIG. 3 after the example processing method depicted in FIGS. 4 and 5;

FIG. 8 is a top plan view of a second example tooling system of the present invention with legs and sheet structure removed;

FIG. 9 is a partial side elevation view of the second example tooling system;

FIG. 10 is a section view of the second example tooling system taken along lines 10-10 in FIG. 8;

FIG. 11 is a section view taken along lines 11-11 in FIG. 8 depicting an example fixed foot assembly used by the second example tooling system;

FIG. 12 is a section view taken along lines 12-12 in [0021] FIG. 8 depicting a first example adjustable foot assembly used by the second example tooling system;

FIG. 13A is a section view taken along lines 13A-13A in FIG. 9 depicting a first example attachment system used by the second example tooling system;

FIG. 13B is a section view similar to FIG. 13A depicting a second example attachment system that may be used by the first and second example tooling systems;

FIG. 13C is a section view similar to FIG. 13A depicting a third example attachment system that may be used by the first and second example tooling systems;

FIG. 14 is a section view taken along lines 14-14 in FIG. 8 depicting a first example handling system used by the second example tooling system;

FIG. 15 is a partial side elevation view of a third example tooling system of the present invention;

FIG. 16 is a section view taken along lines 16-16 in FIG. 15 depicting a fourth example attachment system and a second example adjustable foot assembly used by the third example tooling system;

FIG. 17 is an enlarged section view depicting detail of the fourth example attachment system shown in FIG. 16;

FIG. 18 is an enlarged section view depicting detail of the fourth example attachment system shown in FIG. 16; and

FIG. 19 is a section view taken along lines 19-19 in FIG. 15.

### DETAILED DESCRIPTION

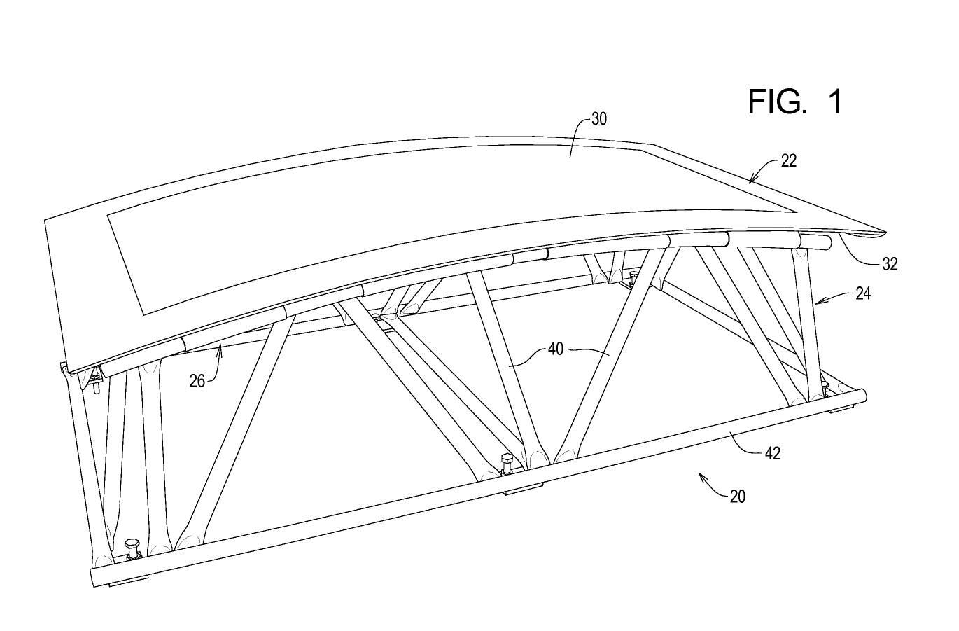

Referring initially to FIG. 1 of the drawing, depicted at 20 therein is a first example tooling system constructed in accordance with, and embodying, the principles of the present invention. The tooling system 20 comprises an example sheet structure 22, an example truss structure 24, and example attachment structures 26.

The example sheet structure 22 is a carbon composite structure defining a mold surface 30 and a reverse surface 32. The mold surface 30 takes the form of the part to be made using the tooling system 20. The attachment structures 26 are adhered to the reverse surface 32 and extend around a portion of the truss structure 24 to secure the sheet structure 22 relative to the truss structure 24. The attachment structures 26 allow controlled movement of the sheet structure 22 relative to the truss structure 24.

The example truss structure 24 is an assembly of truss components 40. Optionally, base components 42 are provided to form a ground engaging portion of the truss structure 24. In the example tooling system 20, the example truss components 40 take the form of hollow circular tubes having a tube diameter of approximately 1.67″ and a wall thickness of approximately 0.125″. The tube diameter is typically within a first range of approximately 1.5″ to 2.0″ and in any event should be within a second range of 1.0″ to 2.5″. The wall thickness is typically within a first range of approximately 0.12″ to 0.13″ and should be within a second range of 0.065″ to 0.20″ or within a third range of 0.10″ to 0.20″. The exact parameters of the truss components 40 should be determined based on axial stiffness and buckling requirements established by the operating parameters of the tooling system 20.

The example truss components 40, and, if used, the example base components 42, are made of Invar; the Applicant has found that Invar 36 satisfies the operating requirements of a tooling system of the present invention. In particular, the coefficient of thermal expansion of Invar is approximately the same as that of the sheet structure 22.

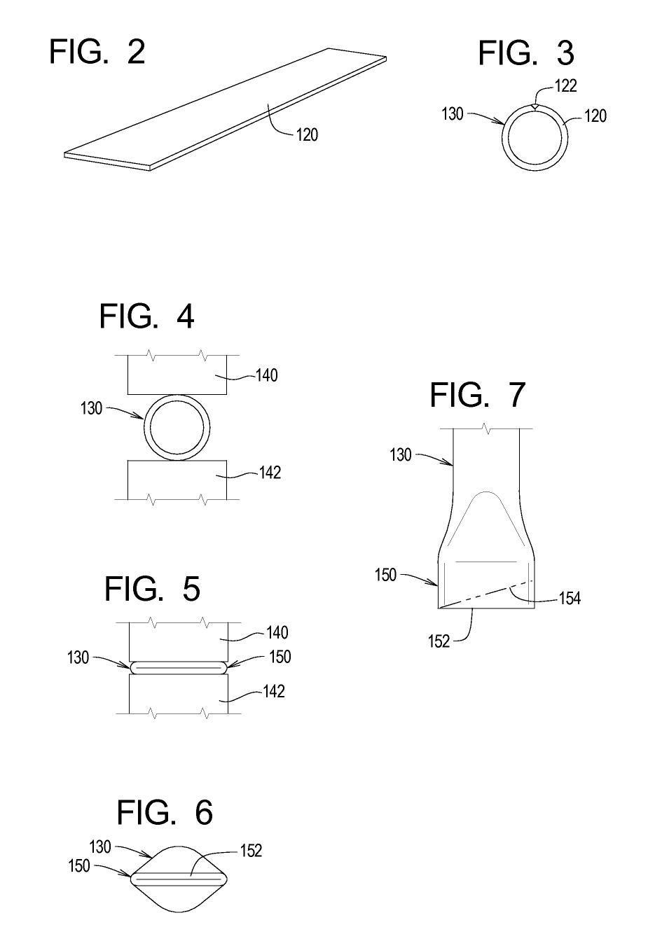

Referring now to FIGS. 2-8 of the drawing, the fabrication of the example truss components 40 will be described in further detail. FIG. 2 depicts stock material 120 from which the truss components 40 are made. The example stock material 120 initially takes a sheet or strip form and is worked to obtain a circular shape as generally depicted in FIG. 3. The stock material 120 may be worked to obtain other geometric configurations, such as a square or rectangular shape with rounded corners, so long as the axial stiffness and buckling requirements of the tooling system 20 are met.

FIG. 3 further illustrates that a weld 122 is formed along the length of stock material 120 in the circular shape. After the weld 122 is formed, the stock material takes the form of a stock member 130 that may be used as raw material for the formation of the truss components 40.

In particular, as shown in FIGS. 4 and 5, the stock member 130 is initially cut approximately to length as determined by the size and dimensions of the truss structure 24. One or both ends of the stock member 130 are pinched between clamp members 140 and 142 to obtain a pinched end 150 of the stock member 130.

As shown in FIGS. 6 and 7, the pinched end 150 defines an end edge 152 suitable for welding to another one of the stock members 130, again as determined by the size and dimensions of the truss structure 24. Broken line 154 in FIG. 7 illustrates that pinched end 150 may be sheared or otherwise cut at an angle relative to the longitudinal axis of the stock member 130 to facilitate welding to another one of the stock members 130 as required by the shape of the truss structure 24.

Referring now to FIG. 1 of the drawing, the example attachment structures 26 engage the truss structure 24 and are attached to the sheet structure 22 such that the sheet structure 22 is adequately supported by the truss structure 24 under all conditions under which the tooling system 20 is used. In the example tooling system 20, the attachment structures 26 mechanically engage the truss structure 24 and are adhered to the sheet structure 22. Additionally, each of the example attachment structures 26 defines an attachment axis that is substantially aligned with the lengthwise axis of the sheet structure 22. The attachment structures 26 flex to allow slight, controlled movement of the sheet structure 22 relative to the truss structure 24.

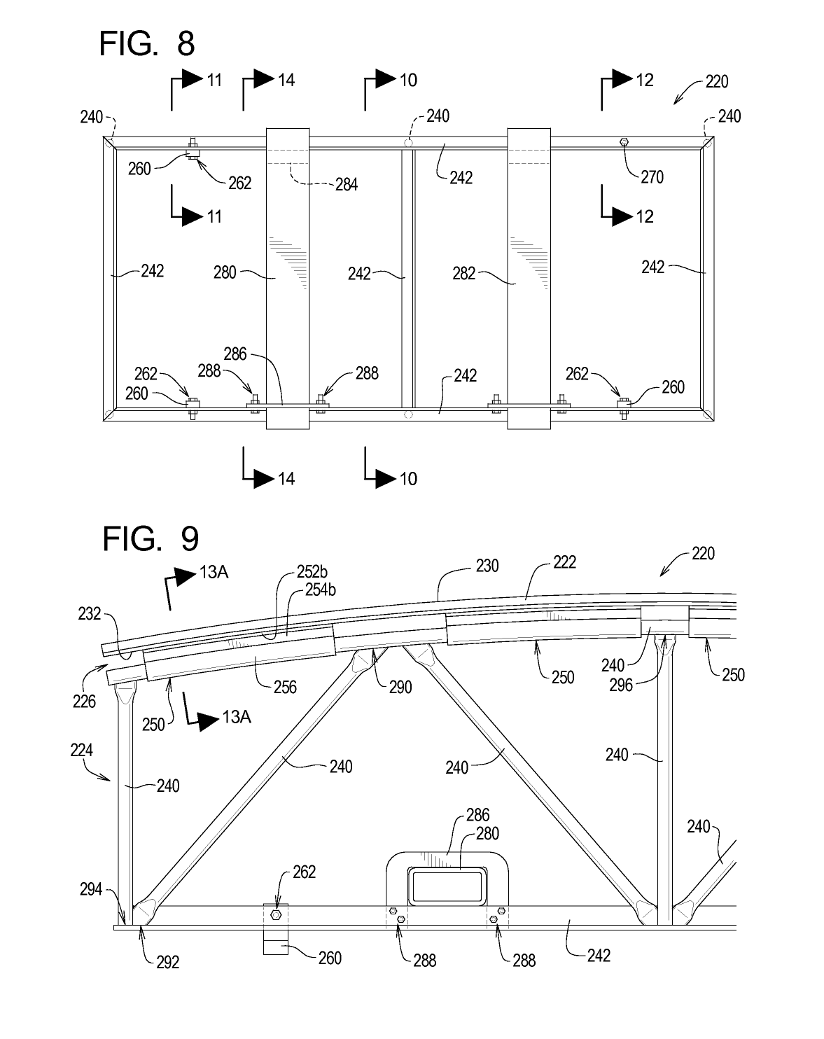

Referring now to FIGS. 8-14 of the drawing, depicted at 220 therein is a second example tooling system constructed in accordance with, and embodying, the principles of the present invention. The second example tooling system 220 comprises an example sheet structure 222, an example truss structure 224, and an example attachment system 226.

The example sheet structure 222 is a carbon composite structure defining a mold surface 230 and a reverse surface 232. The mold surface 230 takes the form of the part to be made using the tooling system 220.

The example truss structure 224 is an assembly of truss components 240 and base components 242.

The example truss components 240 take the form of hollow circular tubes having a tube diameter of approximately 1.67″ and a wall thickness of approximately 0.125″. The tube diameter is typically within a first range of approximately 1.5″ to 2.0″ and in any event should be within a second range of 1.0″ to 2.5″. The wall thickness is typically within a first range of approximately 0.12″ to 0.13″ and should be within a second range of 0.065″ to 0.20″ or within a third range of 0.10″ to 0.20″. The exact parameters of the truss components 240 should be determined based on axial stiffness and buckling requirements established by the operating parameters of the tooling system 220. The example truss components 240 may be made by the same process depicted in, and described above with reference to, FIGS. 2-7.

The example base components 242 are L-shaped in cross-section and thus define first and second portions 244 and 246. In the example base components 240, the first and second portions 244 and 246 are approximately equal in length and both have a length of approximately 2.00″ and a plate thickness of approximately 0.12″. The length of the first and second portions 244 and 246 need not be the same and are typically within a first range of approximately 1.50″ to 2.50″ and in any event should be within a second range of approximately 1.00″ to 5.00″. The plate thickness is typically within a first range of approximately 0.10″ to 0.15″ and should be within a second range of 0.065″ to 0.25″. The exact parameters of the base components 242 should be determined based on axial stiffness and buckling requirements established by the operating parameters of the tooling system 220. The example base components 242 may be made of flat stock material such as the stock material 120 depicted above bent to take on the L-shape depicted in FIGS. 11 and 12.

The example truss components 240 and base components 242 are made of Invar; the Applicant has found that Invar 36 satisfies the operating requirements of a tooling system of the present invention. In particular, the coefficient of thermal expansion of Invar is approximately the same as that of the sheet structure 222. Accordingly, when the tooling system 220 is placed in a heated environment, the structural integrity of the tooling system 220 is maintained.

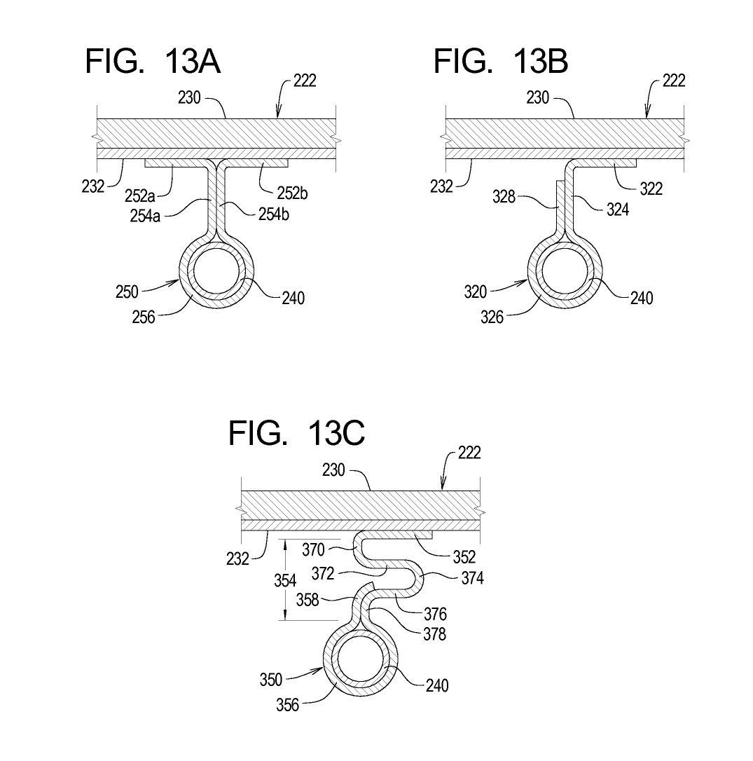

As perhaps best shown in FIGS. 9 and 13A, the example attachment system 226 comprises a plurality of composite panels 250 that are arranged to form a structure defining first and second tab portions 252a and 252b, first and second leg portions 254a and 254b, and a loop portion 256 that extends around one of the truss components 240. Resin is applied to the panels 250, and, when the resin sets, the tab portions 252a and 252b are adhered by the resin to the reverse surface 232 and the composite panels 250 hold the shape depicted in FIG. 13A.

The panels 250 thus form the attachment system 226 to secure the sheet structure 222 relative to the truss structure 224 during transportation and handling of the tooling system 220 and during use of the tooling system 220 to form a part. However, the attachment system 226 formed by the composite panels 250 is flexible to allow slight, controlled movement of the sheet structure 222 relative to the truss structure 224 to inhibit damage to the sheet structure 222 during transportation and handling of the tooling system 220.

Referring now to FIGS. 8, 9, 11, and 12, an example support system used with the second example tooling system 220 will now be described. FIG. 8 illustrates that the example support system used by the second example tooling system 220 comprises three fixed feet 260 secured to the based components 242 by bolt assemblies 262 and one adjustable foot 270. FIG. 11 illustrates that the fixed feet 260 are configured to transfer loads on the truss structure 224 to a support surface (not shown) such as a floor. FIG. 12 illustrates that the adjustable foot 270 extends through a hole in the first portion of 244 of the base component 242 and is secured relative to the base component by 242 first and second nuts 272 and 274 and a washer 276. The nuts 272 and 274 allow an effective length of the adjustable foot 270 to be configured such that the example tooling system 220 is stably supported by the support surface.

Referring now to FIGS. 8, 9, and 14, an example handling system used by the second example tooling system 220 will now be described. FIG. 8 illustrates that the example handling system comprises first and second pipe structures 280 and 282. The example pipe structures 280 and 282 are secured to parallel base components 242 of the truss structure 224 to facilitate movement of the tooling system 220. In particular, the forks of a forklift may be inserted into the pipe structures 280 to lift and displace the second example tooling system 220.

Although the first and second pipe structures 280 and 282 may, like the truss components 240 and base components 242, be made of Invar, the example handling system used by the second example tooling system 220 employs steel pipe structures 280 and 282 to reduce costs. However, because steel has a coefficient of thermal expansion that is different from that of the truss components 240 and base components 242 made of Invar, the example pipe structures 280 and 282 are secured relative to the truss structure 224 in a manner that accommodates these differing coefficients of thermal expansion.

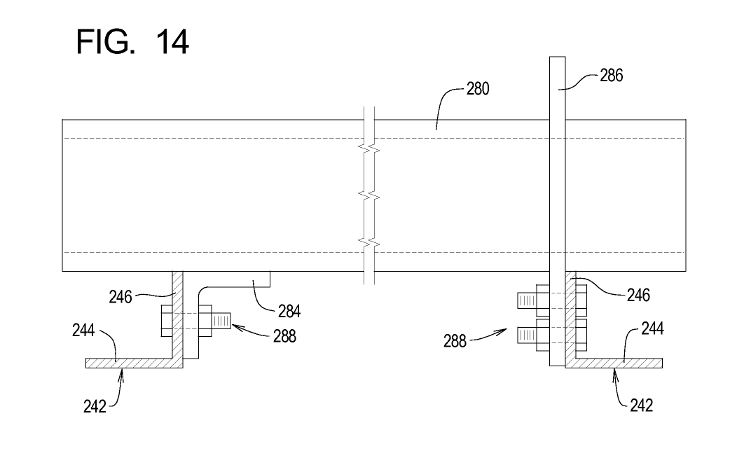

In particular, with the handling system used by the second example tooling system 220, a brace member 284 is welded to each of the pipe structures 280 and 282. A collar member 286 is sized and dimensioned to extend around the pipe structures 280 and 282 as shown in FIG. 9. The brace members 284 and collar members 286 are secured to the base components 242 using bolt assemblies 288 with the pipe structures 280 and 282 extending through the collar members 286 as perhaps best shown in FIG. 14. Both ends of the pipe structures 280 and 282 are effectively secured to the parallel base portions 242 when the pipe structures 280 and 282 are lifted using a forklift. And when the tooling system 220 is heated, any difference in the dimensions of the pipe structures 280 and 282 relative to the dimensions of the truss structure 224 is accommodated by allowing the end of the pipe structures 280 and 282 captured by the collar members 286 to extend through the collar members 286.

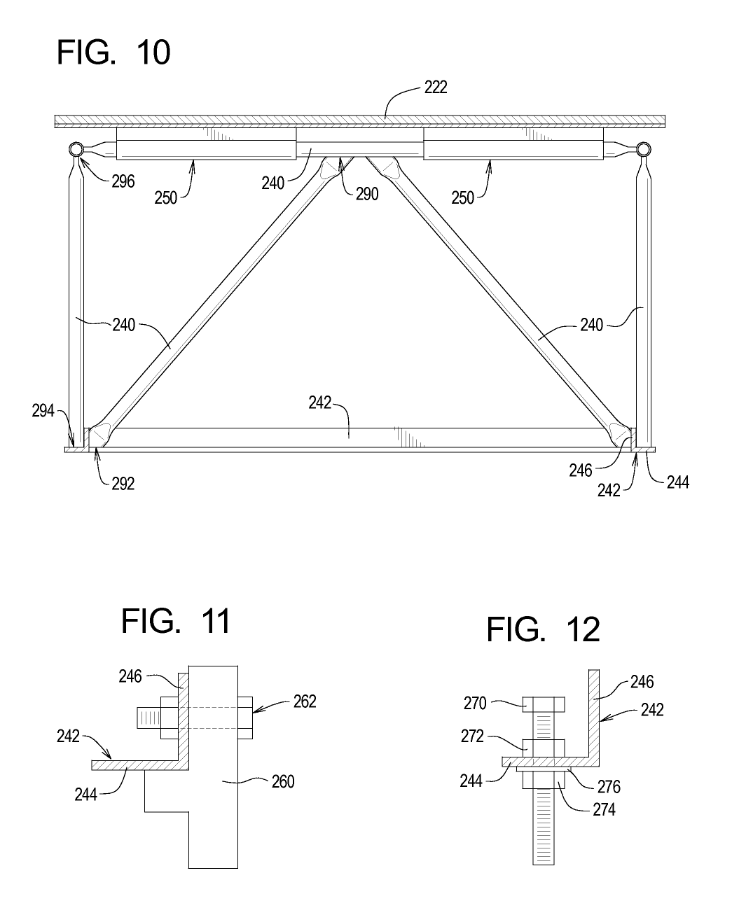

Referring for a moment back to FIGS. 9 and 10, it can be seen that a number of different joint types may be used to form the example truss structure 224 using the example truss components 240 and the example base components 242. Depicted at 290 are examples of angle joints that can be formed by shearing the pinched ends of the truss components 240 as described above with reference to the example truss components 40 described above. The sheared pinched ends thus are formed at an angle appropriate for welding to another one of the truss components 240 or to one of the base components 242. Corner joints depicted at 292 are formed by forming two shear cuts at the pinched ends of the truss components 240 so that the truss components 240 can be welded to two intersecting surfaces as formed by the intersection of the truss components 240 and base components 242. Butt joints as depicted at 294 are formed by welding the ends of the truss components 240 to a parallel surface formed by one of the base components 242. Edge joints as depicted at 296 are formed by welding the pinched ends of truss components 240 to a parallel surface formed by another one of the truss components 240.

FIGS. 13B and 13C depict two alternative attachment systems that may be used in place of the example attachment system 226 described above.

FIG. 13B illustrates an example attachment system comprising a plurality of composite panels 320 that are arranged to form a structure defining a tab portion 322, a leg portion 324, a loop portion 326, and an overlap portion 328. The loop portion 326 extends around one of the truss components 240. Resin is applied to the panels 320, and, when the resin sets, the tab portions 322 are adhered by the resin to the reverse surface 232, and the composite panels 320 hold the shape depicted in FIG. 13B.

The panels 320 thus form an attachment system that may be used in place of the example attachment system 226 to secure the sheet structure 222 relative to the truss structure 224 during transportation and handling of the tooling system 220 and during use of the tooling system 220 to form a part. However, the attachment system 226 formed by the composite panels 320 allows slight movement of the sheet structure 222 relative to the truss structure 224 to inhibit damage to the sheet structure 222 during transportation and handling of the tooling system 220.

FIG. 13C illustrates an example attachment system comprising a plurality of composite panels 350 that are arranged to form a structure defining a tab portion 352, a leg portion 354, a loop portion 356, and an overlap portion 358. The loop portion 356 extends around one of the truss components 240. The leg portion 354 defines a first spacing portion 370, a first lateral portion 372, a second spacing portion 374, a second lateral portion 376, and a third spacing portion 378. Resin is applied to the panels 350, and, when the resin sets, the tab portions 352 are adhered by the resin to the reverse surface 232, and the composite panels 350 hold the shape depicted in FIG. 13C.

The panels 350 thus form an attachment system that may be used in place of the example attachment system 226 to secure the sheet structure 222 relative to the truss structure 224 during transportation and handling of the tooling system 220 and during use of the tooling system 220 to form a part. However, the attachment system 226 formed by the composite panels 350 allows slight movement of the sheet structure 222 relative to the truss structure 224 to inhibit damage to the sheet structure 222 during transportation and handling of the tooling system 220. The use of the spacing portions 370, 374, and 378 and lateral portions 372 and 376 increases the amount of movement allowed between the sheet structure 222 and the truss structure 224 relative to the movement allowed by the shapes of the composite panels 250 and 320 as described above.

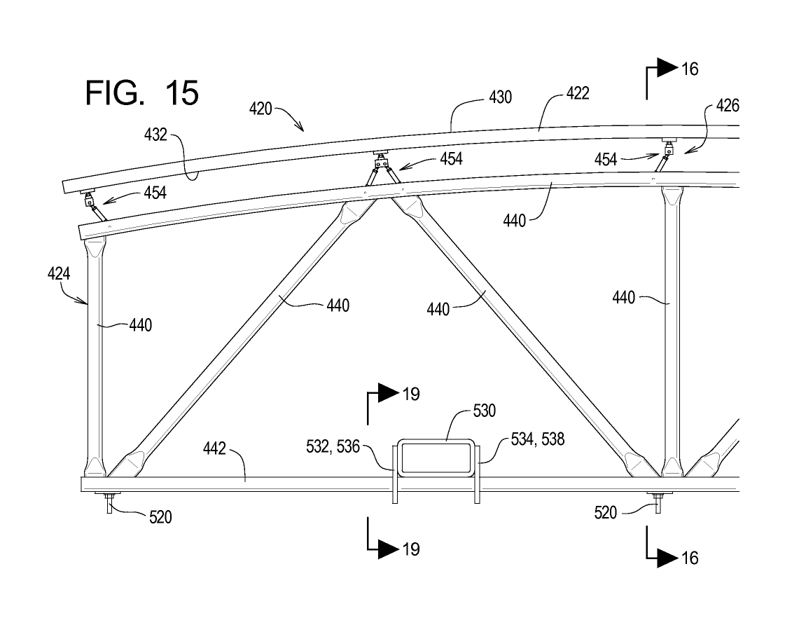

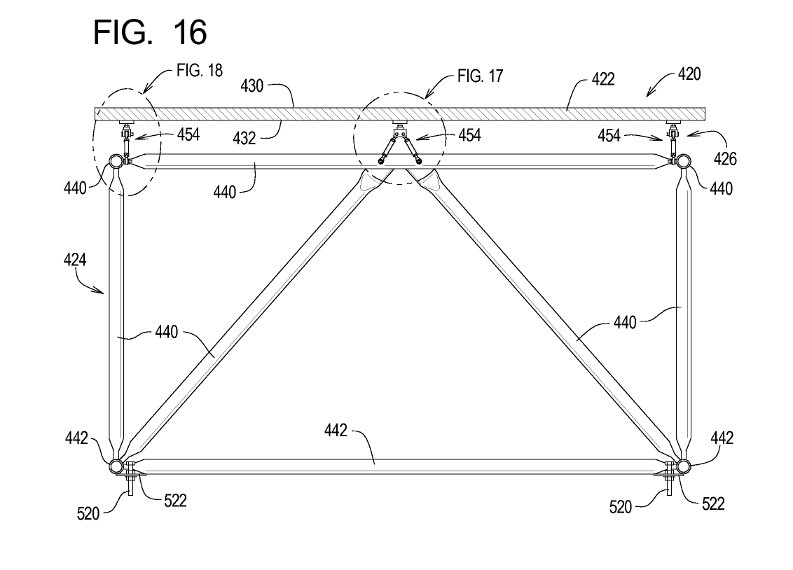

Referring now to FIGS. 15-19 of the drawing, depicted at 420 therein is a third example tooling system constructed in accordance with, and embodying, the principles of the present invention. The third example tooling system 420 comprises an example sheet structure 422, an example truss structure 424, and an example attachment system 426. The attachment system 426 allows slight, controlled movement of the sheet structure 422 relative to the truss structure 424.

The example sheet structure 422 is a carbon composite structure defining a mold surface 430 and a reverse surface 432. The mold surface 430 takes the form of the part to be made using the tooling system 420.

The example truss structure 424 is an assembly of truss components 440 and base components 442.

The example truss components 440 take the form of hollow circular tubes having a tube diameter of approximately 1.67″ and a wall thickness of approximately 0.125″. The tube diameter is typically within a first range of approximately 1.5″ to 2.0″ and in any event should be within a second range of 1.0″ to 2.5″. The wall thickness is typically within a first range of approximately 0.12″ to 0.13″ and should be within a second range of 0.065″ to 0.20″ or a third range of 0.10″ to 0.20″. The exact parameters of the truss components 440 should be determined based on axial stiffness and buckling requirements established by the operating parameters of the tooling system 420. The example truss components 440 may be made by the same process depicted in, and described above with reference to, FIGS. 2-7.

The example base components 442 also take the form of hollow circular tubes having a tube diameter of approximately 1.67″ and a wall thickness of approximately 0.125″. The tube diameter is typically within a first range of approximately 1.5″ to 2.0″ and in any event should be within a second range of 1.0″ to 2.5″. The wall thickness is typically within a first range of approximately 0.12″ to 0.13″ and should be within a second range of 0.065″ to 0.20″ or a third range of 0.10″ to 0.20″. The exact parameters of the base components 442 should be determined based on axial stiffness and buckling requirements established by the operating parameters of the tooling system 420. The example base components 442 may be made by the same process depicted in, and described above with reference to, FIGS. 2-3. Unlike the truss components 440, however, the base components 442 need not be crimped or stamped at the ends.

The example truss components 440 and base components 442 are made of Invar; the Applicant has found that Invar 36 satisfies the operating requirements of a tooling system of the present invention. In particular, the coefficient of thermal expansion of Invar is approximately the same as that of the sheet structure 422. Accordingly, when the tooling system 420 is placed in a heated environment, the structural integrity of the tooling system 420 is maintained.

As shown in FIGS. 15-18, the example attachment system 426 comprises a plurality of connector bases 450, composite panels 452, clevis assemblies 454, leg assemblies 456, and truss bolt assemblies 458. The composite panels 452 are impregnated with resin and applied over the connector bases 450 and against the reverse surface 432 to secure the connector bases 450 at appropriate locations on the reverse surface 432. The clevis assemblies 454 movably connect the leg assemblies 456 to the connector bases 450, and the leg assemblies 456 are in turn movably connected to the truss structure 424 by the truss bolt assemblies 458.

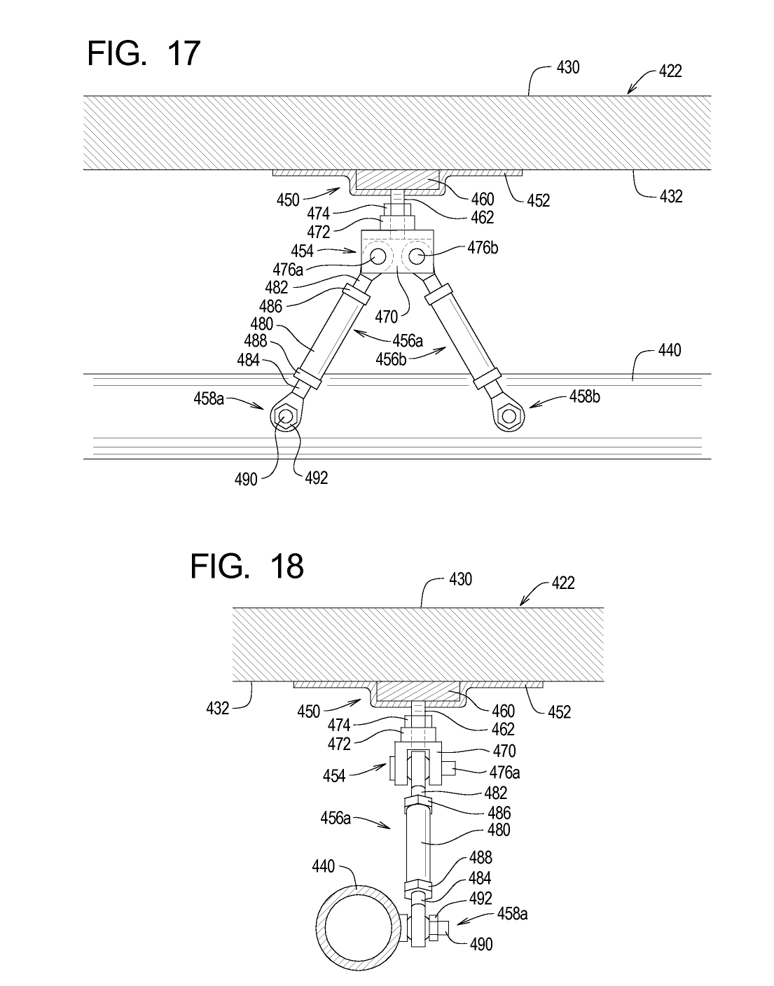

More specifically, FIGS. 17 and 18 illustrate that the connector bases 450 comprise a base plate 460 and a threaded rod 462. The threaded rod 462 is integrally formed with or welded to the base plate 460 such that the connector bases 450 are rigid structures.

The clevis assemblies 454 may be either single clevis or double clevis as shown in FIG. 15, and an example of a double clevis assembly 454 is depicted in detail in FIGS. 17 and 18. The example double clevis assembly 454 of FIGS. 17 and 18 comprises a clevis plate 470, a clevis collar 472, a clevis nut 474, and a pair of clevis pins 476a and 476b. The clevis plate 470 is a U-shaped body that defines a central portion and two side portions. The clevis collar 472 is integrally formed with or welded to the central portion of the clevis plate and defines a threaded opening for receiving the threaded rod 462. The clevis nut 474 receives the threaded rod 462 to secure a position of the clevis assembly 454 relative to the connector base 450. The clevis pins 476a and 476b each extend between the side portions of the clevis plate 470 to support the ends of the leg assemblies 456a and 456b for pivoting movement relative to the clevis plate 470.

The leg assemblies 456a and 456b each comprise a leg cylinder 480, first and second leg bolts 482 and 484, and first and second leg nuts 486 and 488. The leg cylinder 480 is internally threaded to receive the leg bolts 482 and 484. The leg nuts 486 and 488 are threaded onto the leg bolts 482 and 484 to secure positions of the leg bolts 482 and 484 relative to the leg cylinder 480, respectively. The leg bolts 482 and 484 further define holes, with the clevis pins 476 extending through the hole in the first leg bolt 482 and the truss bolt assembly 458 extending through the hole in the second leg bolt 484 as will be described in further detail below.

The truss bolt assemblies 458 each comprise a truss bolt 490 and a truss nut 492. The truss bolts 490 are welded or otherwise secured at appropriate points to the truss components 440. The truss bolts 490 extend through the holes in the second leg bolts 484, and the truss nuts 492 are threaded onto the truss bolts 490 to rotatably attach the second leg bolts 484 relative to the truss structure 424.

The attachment system 426 thus secures the sheet structure 422 relative to the truss structure 424 during transportation and handling of the tooling system 420 and during use of the tooling system 420 to form a part. However, the attachment system 426 allows slight movement of the sheet structure 422 relative to the truss structure 424 to inhibit damage to the sheet structure 422 during transportation and handling of the tooling system 420.

Referring now to FIGS. 15, 16, and 19, an example support system used with the third example tooling system 420 will now be described. The example support system used by the third example tooling system 420 comprises a plurality of adjustable feet 520 secured to the base components 442. The adjustable feet 520 extend through holes in a foot plate 522 secured to the base components 442. First and second nuts 524 and 526 and a washer 528 are configured to secure the adjustable feet 520 at a desired position relative to the foot plate 522 as necessary to stabilize the tooling system 420 on a support surface (not shown) such as a floor.

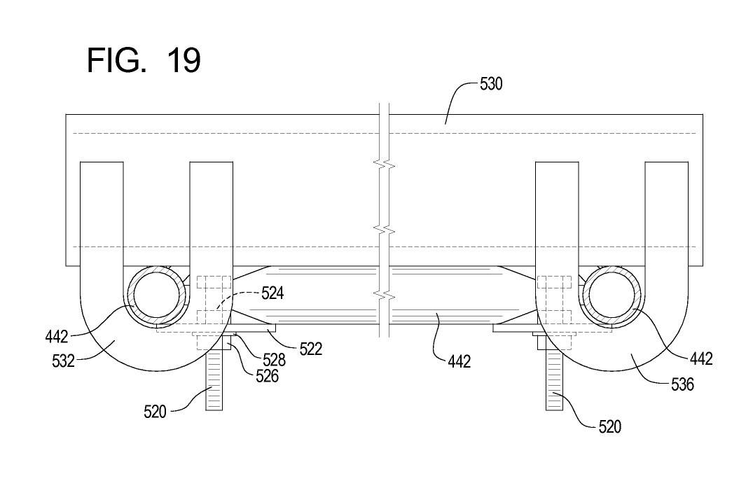

Referring now to FIGS. 15 and 19, an example handling system used by the third example tooling system 420 will now be described. The example handling system comprises a pair of pipe structures 530, only one of which is visible in the drawings. First, second, third, and fourth hoop structures 532, 534, 536, and 538 are secured to each of the pipe structures 530. The hoop structures 532, 534, 536, and 538 surround sections of the base components 442 to facilitate movement of the tooling system 420. In particular, the forks of a forklift may be inserted into the pipe structures 530 to lift and displace the third example tooling system 420.

Although the pipe structure 530 may, like the truss components 440 and base components 442, be made of Invar, the example handling system used by the third example tooling system 420 employs steel pipe structures 530 to reduce costs. Because steel has a coefficient of thermal expansion that is different from that of the truss components 440 and base components 442 made of Invar, the hoop structures 532, 534, 536, and 538 are slightly oversized relative to the base components 442 to accommodate increased expansion of the pipe structures 530 relative to the truss structure 424 due to the differing coefficients of thermal expansion.

Both ends of the pipe structures 530 are thus effectively secured to the parallel base components 442 by the hoop structures 532-538 when the pipe structures 530 are lifted using a forklift. And when the tooling system 420 is heated, any difference in the dimensions of the pipe structures 530 relative to the dimensions of the truss structure 424 is accommodated by oversizing of the hoop structures 532-538 relative to the base components 442.

What is claimed is:

1. A tooling system for forming a part comprising:
a sheet structure defining a mold surface for defining at least a portion of the part, where the sheet structure is a carbon fiber composite structure;
a truss structure comprising a plurality of truss components, where
the truss components are tubular,
the truss components are made of Invar,
at least one end of each of the truss components is crimped, and
crimped ends of the truss components are welded to other truss components to form the truss structure; and
an attachment system for securing the sheet structure to the truss structure.

2. A tooling system as recited in claim 1, in which the truss structure further comprises at least one base component, where:
the base components are made of Invar; and
crimped ends of the truss components are welded to the base components to form the truss structure.

3. A tooling system as recited in claim 1, in which the attachment system allows movement of the sheet structure relative to the truss structure.

4. A tooling system as recited in claim 1, in which the attachment system comprises at least one resin-impregnated composite sheet that is bonded to the sheet structure and extended at least partly around a portion of the truss structure.

5. A tooling system as recited in claim 1, in which the attachment system comprises at least one clevis assembly and at least one leg assembly, where at least one clevis assembly and at least one leg assembly are attached between the sheet structure and the truss structure.

6. A tooling system as recited in claim 1, in which the truss components comprise welded plates.

7. A tooling system as recited in claim 1, in which at least one of the crimped ends of at least one of the truss components is sheared.

8. A method of forming a tooling system for forming a part comprising the steps of:
providing a sheet structure defining a mold surface for defining at least a portion of the part, where the sheet structure is a carbon fiber composite structure;
providing a plurality of tubular truss components made of Invar;
crimping at least one end of each of the truss components;
forming a truss structure by welding the crimped ends of the truss components to other truss components; and
securing the sheet structure to the truss structure.

9. A method as recited in claim 8, in which step of forming the truss structure further comprises the steps of:
providing at least one base component made of Invar; and
welding the crimped ends of the truss components to the base components.

10. A method as recited in claim 8, in which the step of securing the sheet structure to the truss structure further comprises the step of allowing movement of the sheet structure relative to the truss structure.

11. A method as recited in claim 8, in which the step of securing the sheet structure to the truss structure further comprises the steps of:
bonding at least one resin-impregnated composite sheet to the sheet structure; and
extending at least part of the at least one composite sheet at least partly around a portion of the truss structure.

12. A method as recited in claim 8, in which the step of securing the sheet structure to the truss structure further comprises the steps of:
providing at least one clevis assembly;
providing at least one leg assembly; and
attaching at least one clevis assembly and at least one leg assembly between the sheet structure and the truss structure.

13. A method as recited in claim 8, in which the step of providing the truss components comprises the steps of:
providing a plurality of flat plates;
forming the plurality of flat plates into a cylindrical configuration; and
welding each of the flat plates along a seam to form the truss components.

14. A method as recited in claim 8, further comprising the step of shearing at least one of the crimped ends of one of the truss components.

15. A method of forming a tooling system for forming a part comprising the steps of:
providing a sheet structure defining a mold surface for defining at least a portion of the part, where the sheet structure is a carbon fiber composite structure;
providing a plurality of flat plates made of Invar;
forming the plurality of flat plates into a cylindrical configuration;
forming a plurality of tubular truss components by welding each of the flat plates along a seam to form the truss components;
crimping at least one end of each of the truss components;
shearing at least one of the crimped ends of one of the truss components;
forming a truss structure by welding the crimped ends of the truss components to other truss components; and
securing the sheet structure to the truss structure.

16. A method as recited in claim 15, in which the step of forming the truss structure further comprises the steps of:
providing at least one base component made of Invar; and
welding the crimped ends of the truss components to the base components.

17. A method as recited in claim 15, in which the step of securing the sheet structure to the truss structure further comprises the step of allowing controlled movement of the sheet structure relative to the truss structure.

18. A method as recited in claim 15, in which the step of securing the sheet structure to the truss structure further comprises the steps of:
bonding at least one resin-impregnated composite sheet to the sheet structure; and
extending at least part of the at least one composite sheet at least partly around a portion of the truss structure.

19. A method as recited in claim 15, in which the step of securing the sheet structure to the truss structure further comprises the steps of:
providing at least one clevis assembly;
providing at least one leg assembly; and
attaching the at least one clevis assembly and the at least one leg assembly between the sheet structure and the truss structure.
